(19) United States
(12) Patent Application Publication
(10) Pub. No.: US 2026/0097443 A1
(43) Pub. Date: Apr. 9, 2026

(54) CIRCULAR SAW

(71) Applicant: Festool GmbH, Wendlingen am Neckar (DE)

(72) Inventors: Wolfgang Spengler, Neidlingen (DE); Benjamin Allgaier, Römerstein (DE); Andreas Randecker, Dettingen (DE)

(21) Appl. No.: 19/114,208

(22) PCT Filed: Sep. 14, 2023
(86) PCT No.: PCT/EP2023/075354

§ 371 Date: Mar. 21, 2025

(30) Foreign Application Priority Data
Sep. 28, 2022 (DE) 10 2022 125 025.3

(51) Int. Cl. B23D 59/00; B23D 45/04

(52) U.S. Cl. CPC B23D 59/006; B23D 45/048

(57) ABSTRACT

The invention relates to a circular saw, in particular a miter saw or sliding compound miter saw, having a base part (10), which comprises a support (18), wherein a swivel arm (20) is connected to the support (18) so as to swivel about a swivel axis (22), wherein the swivel arm (20) bears a saw head (40), which is designed to receive a saw blade (46) on a saw-blade holder (45), wherein the saw head (40) is coupled to the swivel arm (20) for swiveling about a miter axis of a miter bearing (34), wherein a protective saw blade cover (44) is provided for receiving an area of the saw blade (46), wherein a dust removal means is provided, which is connected to the protective saw blade cover (44) by a first dust guide duct (62), and wherein the dust removal means has a second dust guide duct (70), which extends transverse to the miter axis through or past the swivel arm (20). To achieve an effective removal of the chips produced during the sawing operation from the working area of the machine in such a circular saw, according to the invention provision is made for a dust collection device (60) to be attached at the end of the swivel arm (20) facing away from the saw head (40), which dust collection device comprises a collection container (66) having a collection chamber (66.5) for collecting the saw dust supplied via the first and second dust guide ducts (62 and 70).

The invention relates to a circular saw, in particular a miter saw or a sliding compound miter saw, having a base part, which comprises a table having a workpiece support surface and which has a support, wherein a swivel arm is connected to the support so as to swivel about a swivel axis, wherein the swivel arm bears a saw head, which bears a saw blade on a saw-blade mount, wherein the saw head is coupled to the swivel arm for swiveling about a miter axis of a miter bearing, wherein a protective saw blade cover is provided for receiving an area of the saw blade, wherein a dust removal means is provided, which is connected to the protective saw blade cover by a first dust guide duct, and wherein the dust removal means comprises a second dust guide duct, which extends transverse to the miter axis through or past the swivel arm.

The invention also relates to a dust collection device for a circular saw, in particular for a miter saw or a sliding compound miter saw.

U.S. Pat. No. 5,445,056 discloses a sliding compound miter saw having a swivel arm, which is connected to the table of the circular saw to be able to swivel about a swivel axis. The swivel arm bears the saw head, which can be swiveled by means of a miter bearing between a swiveled-up position and a swiveled-down miter position. This well-known circular saw has a dust removal means to remove the chips produced during sawing. The dust removal means has three guideways. One guideway connects to a protective saw blade cover that encompasses the saw blade in a protective manner. A further guideway connects to a saw slot on the table. A third guideway is guided through the swivel arm. The entry opening of this third guideway is located below the aforementioned protective cover. On the end of the swivel arm facing away from the saw head, the three guideways are joined at a joint connecting piece. A vacuum cleaner can be connected to the connecting piece to generate an air flow during sawing. This achieves a so-called active dust removal means, which can be used to extract the sawdust.

Sometimes there are situations where the craftsperson does not have a suction device for active dust removal at hand. In that case, sawdust contaminates the area encompassing the circular saw.

Passive dust removal solutions are therefore also known from the state of the art, in which no active dust removal is performed. A dust guide duct is guided from the protective saw blade cover to a collection bag for the intake of the chips, as shown for instance in U.S. Pat. No. 5,819,619.

The above-mentioned circular saws using passive chip removal are suitable for collecting some of the sawdust produced during sawing.

However, in certain sawing positions of the saw blade, a large proportion of the sawdust cannot be removed, such that the area encompassing the circular saw continues to be contaminated with dust. For instance, when the saw blade plunges into the workpiece to be processed, the sawdust is conveyed horizontally backwards against the swivel arm and therefore does not enter the dust removal means. The same effect occurs when sawing into the workpiece at only a small infeed.

The invention addresses the problem of providing a circular saw of the type mentioned at the beginning having a passive dust removal means, which permits an effective chip removal in a simple manner.

The invention furthermore addresses the problem of providing a dust collection device for such a circular saw having a passive dust removal means.

The problem relating to the circular saw is solved in that a dust collection device is attached to the end of the swivel arm facing away from the saw head, which dust collection device comprises a collection container having a collection chamber for collecting the saw dust supplied via the first and the second dust guide ducts.

According to the invention, this dust collection device can be used to remove the chips from the protective saw blade cover. A further part of the sawdust can be suitably removed via the second dust guide duct to improve collection efficiency. For instance, the second dust guide duct is located in an area, in which a high amount of sawdust is expected in certain operating positions of the saw head. For instance, the entry opening into this second dust guide duct can be disposed at least partially in the area between the miter bearing and the top face of the table. This is the area where the saw blade plunges into the workpiece during a saw cut. During the plunging process, sawdust is propelled towards the swivel arm and can then be collected and transported away via the second dust guide duct. The two dust guide ducts are guided to the dust collection device for the chips produced during the machining operation to be collected jointly in the collection chamber of the collection container.

In this way, a compact design is provided. In addition, the chips can then be disposed of jointly and uniformly, which significantly facilitates working.

A particularly effective passive chip removal is achieved if provision is made for the second dust guide duct to be guided through the swivel arm, and the second dust guide duct to comprise an entry opening facing the table and an exit opening at the end of the swivel arm facing away from the saw head, and for a straight line of sight to be formed between the exit opening and the entry opening in the direction of an axis extending in parallel to the workpiece support surface.

Preferably, the lower limiting edge of the saw blade can lie in a plane parallel to the workpiece support surface when the saw head is swung up to its maximum position and this plane intersects the entry opening into the second chip guide duct. The entry opening may extend up to or nearly up to the workpiece support surface. This ensures that in almost every swivel position, chips ejected from the saw blade to the rear in the direction of the swivel arm enter the entry opening and thus the second chip guide duct.

To achieve the aforementioned effect, provision may also be made for the second dust guide duct to extend in the area between the miter axis of the miter bearing and the/a workpiece support surface of the table. It is particularly advantageous if the entry opening into the second dust guide duct is located completely below the miter axis of the miter bearing.

According to a possible variant of the invention, provision may be made for the second dust guide duct to comprise an expansion section, which expands the cross-section of the second dust guide duct in the direction facing away from the dust collection device and/or for the second dust guide duct to have a taper section, which tapers the cross-section of the second dust guide duct in the direction facing the dust collection device. The expansion section can also be used to effectively collect a slightly scattering chip flight. The expansion section or the taper section can be used to increase the flow velocity in the second chip guide duct and lower the static pressure. This improves the conveying effect during machining.

Provision may also preferably be made for the taper section and the expansion section to be interconnected, preferably integrally, by means of a guide area. For instance, the guide area can be disposed such that it is guided through the swivel arm. The integral connection significantly reduces the required cost and effort in parts and assembly.

A particularly preferred embodiment of the invention is such that the first dust guide duct comprises a hose section, whose end area facing away from the saw head is guided in a longitudinally displaceable manner in or on a guide piece of the dust collection device.

One possible variant of the invention is such that the first dust guide comprises a hose section, whose end area facing away from the saw head is guided in a longitudinally displaceable manner in or on a guide piece of the dust collection device. The hose section establishes a connection between the saw head and the dust collection device. During operation, the positioning of the saw head in relation to the swivel arm changes. Because the hose section is now disposed to be moved in a longitudinally displaceable manner in or on the guide piece, the adjustment option created in this way can be used to prevent the hose section from being bent too much in different positionings. As a result, the chip flight routed through the first dust guide duct is deflected less strongly, which is conducive to effective chip removal. In addition, the hose section can be made to be sufficiently rigid to bridge the distance between the guide piece and the end area of the hose section facing away from the saw head.

If the circular saw is designed as a sliding compound miter saw, the saw head is disposed on the swivel arm to be able to both swivel about the miter axis and also move linearly in parallel to the workpiece support surface of the table between a front position—further away from the swivel arm—and a rear position—closer to the swivel arm.

The hose section is guided in a space-saving manner if provision is made for the hose section to be guided on the guide piece in such a way that in different setting positions of the saw head, the free end of the hose section protrudes different lengths into an area encompassed by the dust collection device, preferably into the collection chamber. This is particularly advantageous for a sliding compound miter saw if the saw head is mounted on the swivel arm to be displaceably supported between a front position and a rear position.

A simple design can be achieved if provision is made for the guide piece to be formed by a tube section, in which the hose section is accommodated in a longitudinally displaceable manner. If also provision is made for the guide piece to comprise a curved guide section, on which the hose section is guided in a bent manner, then the hose section can be guided along a predetermined path into the collection container to ensure a suitable trajectory for the conveyed chips.

In the context of the invention, provision may be made for the dust collection device to comprise two ports, wherein the first dust guide duct is attached to the one port and the second dust guide duct is attached to the second port. However, it is also conceivable that the two dust guide ducts are merged in a collection section upstream of the dust collection device and the collection section is then routed into the dust collection device.

According to a further variant of the invention, provision may be made for the swivel arm to comprise a fastening section, to which a holder of the dust collection device is attached, preferably detachably, in particular detachably without the need for tools, and for the collection container to be attached to the holder, preferably detachably, in particular detachably without the need for tools. The holder can be used to securely attach the dust collection device to the swivel arm. The detachable (without the need for tools) connection between the holder and the collection container enables a user to detach the collection container from the holder without having to dismantle the holder. The collection container can then be emptied and simply reattached to the holder. This design is advantageously such that the holder forms the connection for the first dust guide duct and/or the second dust guide duct or the aforementioned collection section. This has the advantage that the dust guide ducts do not have to be dismantled to empty the collection container.

The embodiment of the circular saw explained below is a preferred embodiment of the aforementioned circular saw, but also, in connection with the features mentioned at the beginning or the features of the generic term of claim 1, an independent invention per se.

For improved chip removal, provision may be made for the saw head to bear a chip routing element, for the chip routing element to be directly or indirectly connected to the protective saw blade cover, for the chip routing element to delimit a guide area by means of two legs, which are oriented in the direction of the saw blade plane, wherein the chip routing element comprises an aperture, which, at least in the swung-in cutting position of the saw head, establishes a spatial connection between the second dust guide duct and a workholding device of the table. Provision may be made for the guide area to be delimited by means of the two legs and a connecting section connecting the legs, wherein the connecting section is preferably oriented transverse to the saw blade plane, and for the connecting section to comprise the aperture.

Particularly preferably, the chip routing element has a connecting section connecting the legs, wherein the connecting section is oriented transverse to the saw blade plane and the connecting section comprises the aperture.

The chip routing element at least partially bridges the distance between the top face of the workpiece to be machined and the protective saw blade cover. Chips ejected laterally during the machining process are caught by the legs and routed either towards the first dust guide duct or through the aperture into the second dust guide duct. Preferably, the legs and/or—if present—the connecting section are made of an elastic material, at least in the area that is suitable for contact with the top face of the workpiece. The connecting section and/or the legs are then placed on the surface of the workpiece during the cutting operation and elastically deformed to achieve a “seal” and improve the collection result.

If also provision is made for a routing section to be disposed at the saw head, which routing section at least partially covers or delimits a transition area at the top between the entry opening into the second chip guide duct and the protective saw blade cover, then the chip flight towards the entry opening of the second chip guide duct is improved. Preferably, in at least one cutting position of the saw head, the routing section extends into the area of the entry opening of the chip guide duct and/or the second dust guide duct.

Also, provision may be made for the chip routing element to comprise a base part that bears the routing sectioning section.

If the circular saw is designed as a sliding compound miter saw, it is particularly advantageous if the routing section extends into the area of the entry opening of the second chip guide duct and/or into the second dust guide duct in a position of the saw head that is different from the rear position.

Advantageously, additional lateral routing sections are provided at both sides of the routing section, which at least partially laterally delimit the transition area. The area between the entry opening into the second chip guide duct and the protective saw blade cover is then also protected from contamination by chips.

The problem of the invention is also solved by a dust collection device for a circular saw, in particular for a miter saw or a sliding compound miter saw, having a holder and a collection container, which is detachably connected to the holder (without the need for tools) and forms a collection chamber, wherein the collection device comprises two separate duct ports, which establish an air-conveying connection between the collection chamber and the environment and to each of which one dust guide duct can be or is connected.

As already described above, the dust collection device can be used to collect the flying chips from the two dust guide ducts and convey them into a joint collection chamber. The collection chamber can be part of the collection container, which can be detached from the holder. The collection container can then be emptied and reconnected to the holder. Thus, the dust collection device according to the invention can be used to support the passive dust removal from the circular saw in a simple and effective manner.

The dust collection device according to the invention can be characterized in that the holder comprises an attachment device having a locking element, which is designed and equipped to connect the holder interchangeably to a circular saw, in particular to a swivel arm of the circular saw. In this way, the holder can be easily removed from the circular saw, which reduces the transport volume of the circular saw. Furthermore, the holder can then also be easily cleaned.

Particularly preferably, provision is made for the holder to comprise the two duct ports. The collection container can then be removed from the holder without having to dismantle the dust guide ducts.

A compact dust collection device can be designed such that the holder forms a partial housing and the collection container forms a further partial housing, that the two partial housings each comprise a partial cavity, which, in the assembled state of the partial housings, form a receiving chamber. The collection chamber is therefore part of the receiving chamber.

The collection container and the holder are interconnected or can be interconnected via a collection container interface. Advantageously, the collection container can be or is detachably connected to the holder (without the need for tools) via the collection container interface. The collection container interface encompasses a collection container opening, which is used to fluidically connect the collection chamber to the first dust guide duct and to the second dust guide duct.

Advantageously, the collection container or the collection container opening formed by the collection container—in its position installed at the holder—is open at the top. In this way, the collection container including the chips held by the collection chamber can be easily separated from the holder and emptied by allowing the collection container opening to maintain its upward orientation when the collection container and holder are uncoupled.

As described above, it is advantageous if the dust collection device according to the invention is attached to the swivel arm of the circular saw. The swivel arm performs a swivel motion about a swivel axis that is perpendicular to the miter axis and/or parallel to the workpiece support surface.

For the dust collection device not to impede the swivel motion of the swivel arm, or to prevent a collision of the dust collection device when the swivel arm is swiveled, it is advantageous to taper a width of the collection container—i.e. an extension of the collection container in the state installed at the holder transverse to the saw blade plane—in the direction of an end of the collection container facing away from the collection container opening. Advantageously, the collection container has V-shaped surfaces relative to a symmetry plane of the collection container. In this way, a large collection volume can be made available in the collection chamber at the same time.

One conceivable variant of the invention is such that at least one air guide element is disposed in the receiving chamber and/or the collection chamber, wherein preferably provision is made for the air guide element to be integrally connected to a panel of the dust collection device and to project into the collection chamber. The air guide element, which is preferably disposed as a baffle element in the flow path of the chip flight, at least partially absorbs the kinetic energy of the chips. The chips can therefore settle in the collection chamber.

if provision is made for an exhaust air passage device to be provided, wherein the exhaust air passage device is formed by an opening and/or a porous material delimiting the collection chamber, then the cleaned air flow can exit the collection chamber again into the environment. An opening can be provided in the holder or in the collection container, for instance. The opening can be covered by a filter element to prevent chips from escaping. It is also conceivable that a labyrinth is assigned to the opening, which prevents chips from escaping or reduces the number of chips escaping. Additionally or alternatively, a porous material can delimit the collection chamber. It is conceivable that the boundary is formed by a fabric, a net or any other air-permeable surface element. In particular, it is conceivable that the collection container consists entirely or partially of such an air-permeable surface element.

In a further development of the invention, provision may be made for a cable receiving area to be provided on the outer circumference of the collection device, which cable receiving area is designed and equipped to accommodate a wound-up connection cable of the circular saw and wherein the cable receiving area comprises shaped elements, which are designed to prevent the connection cable from slipping off the receiving area.

The invention is explained in greater detail below based on an exemplary embodiment shown in the drawings. In the drawings:

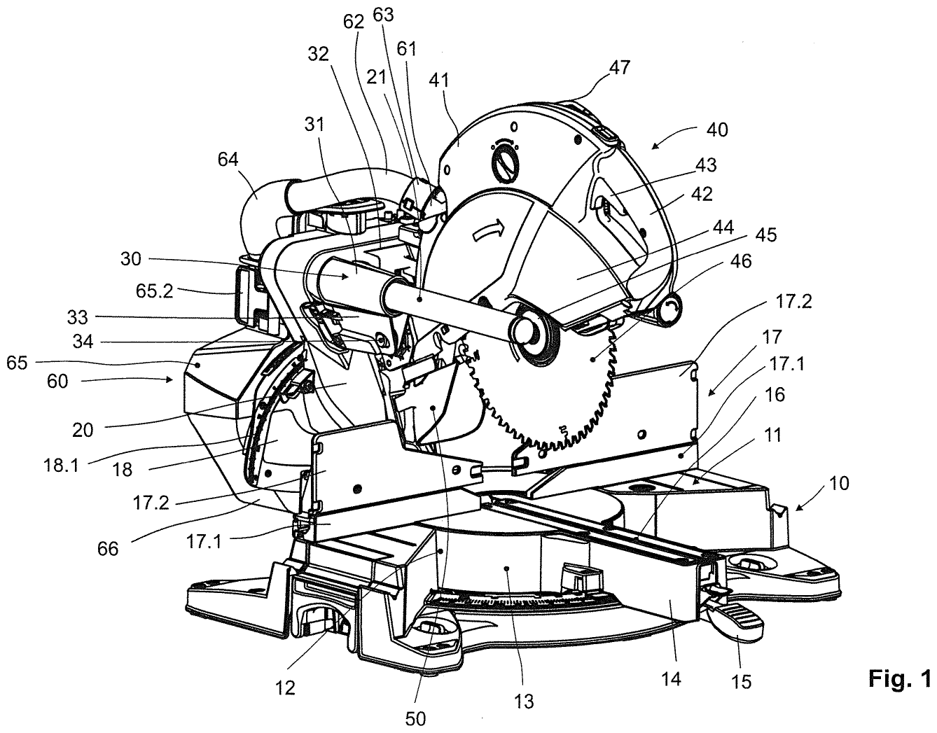

FIG. 1 shows a perspective front view of a sliding compound miter saw,

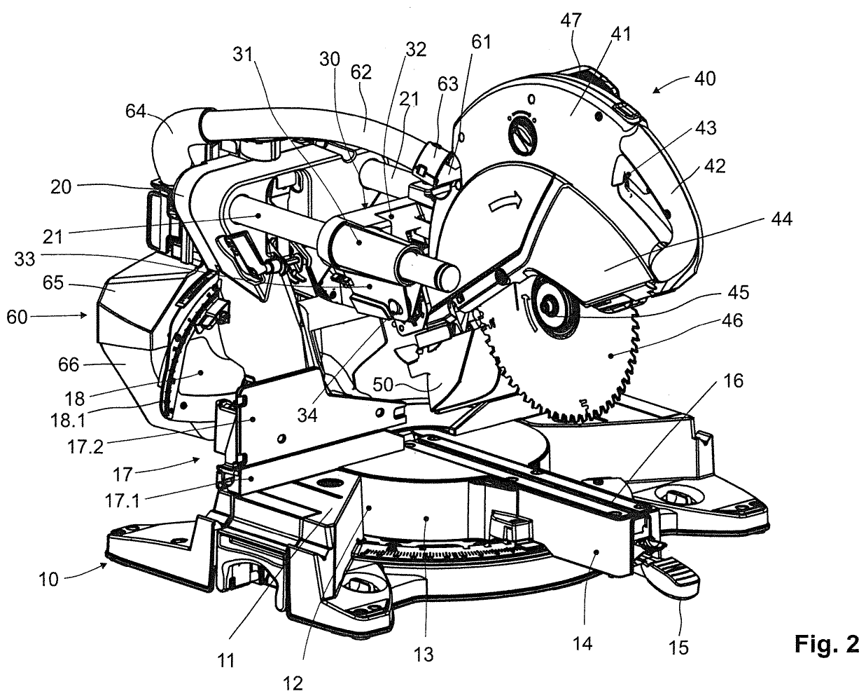

FIG. 2 shows a perspective view from the front of the sliding compound miter saw of FIG. 1 in a changed operating position,

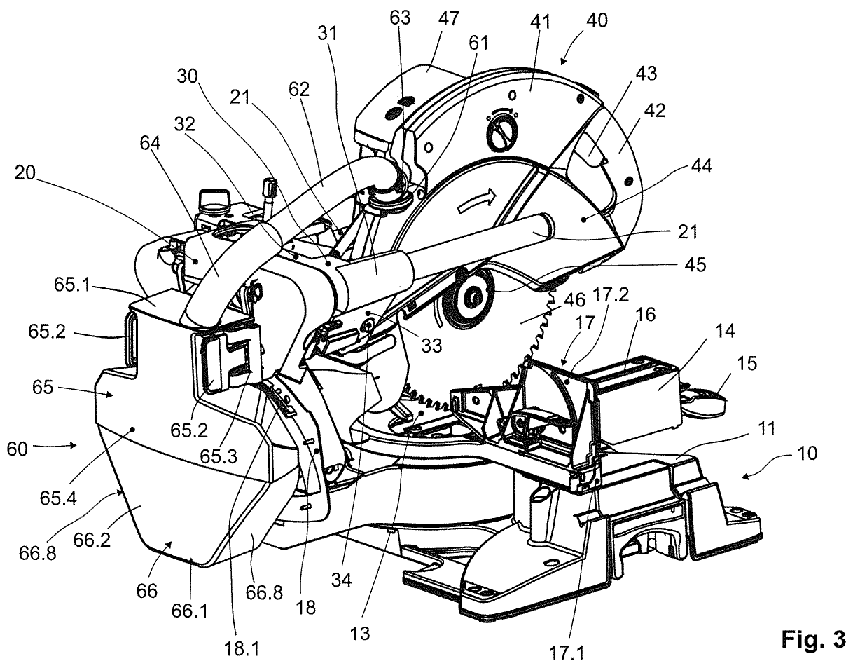

FIG. 3 shows a perspective rear view of the sliding compound miter saw of FIGS. 1 and 2 in a further changed operating position,

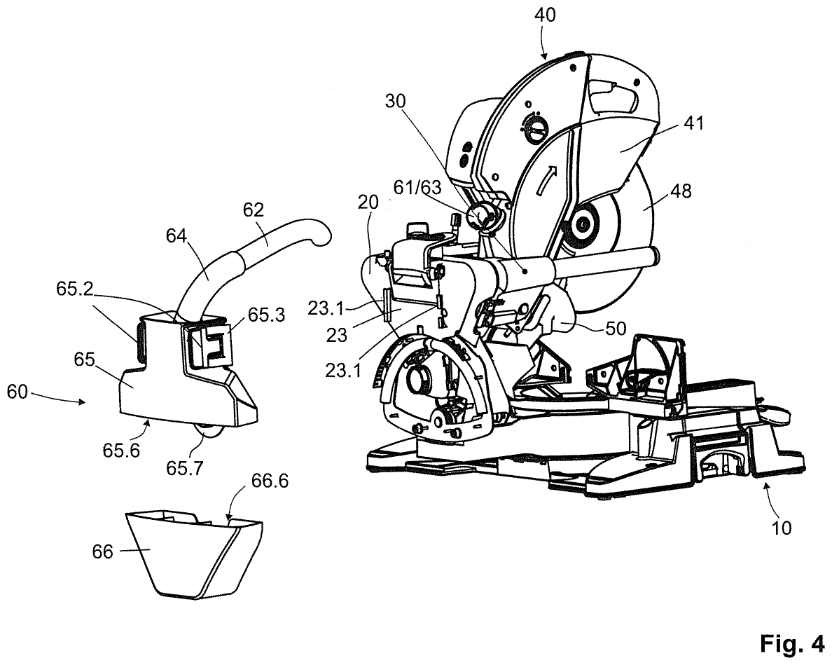

FIG. 4 shows an exploded view of the sliding compound miter saw,

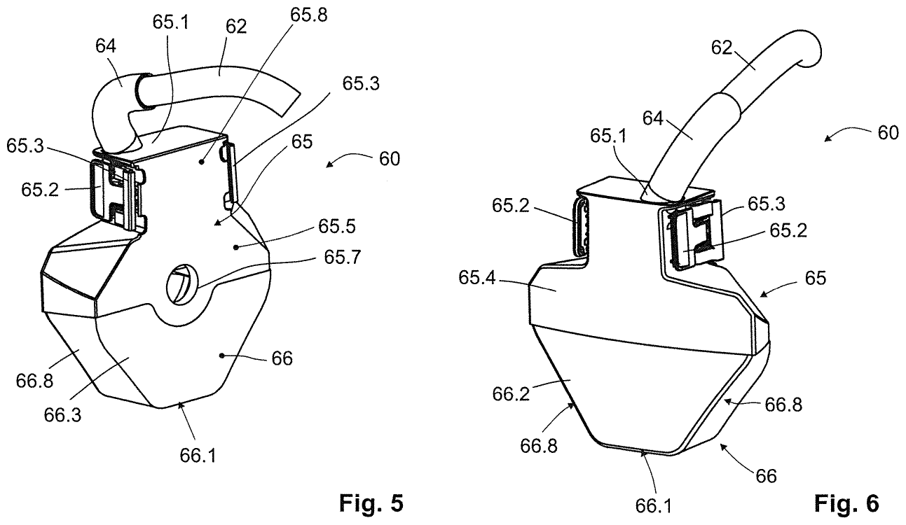

FIG. 5 shows a perspective rear view of a dust collection device,

FIG. 6 shows a perspective front view of the dust collection device of FIG. 5,

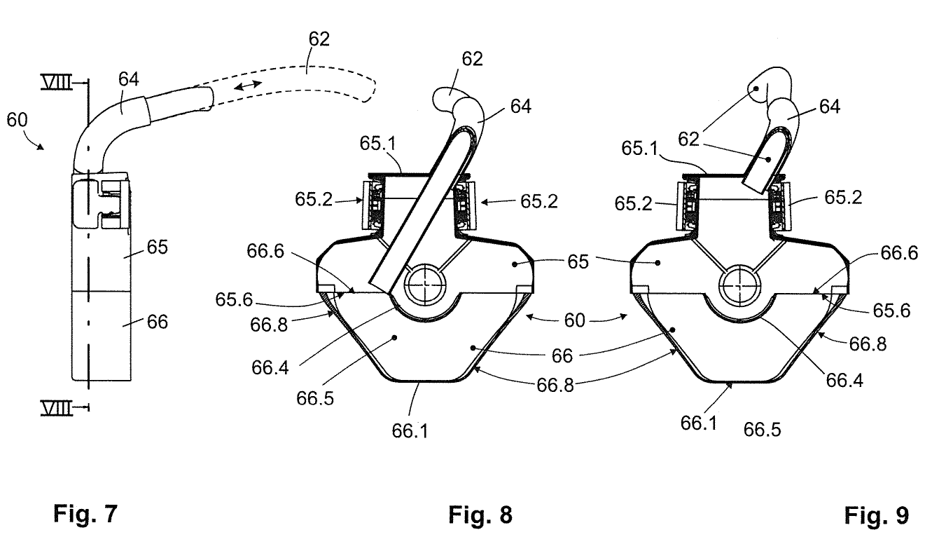

FIG. 7 shows a side view of the dust collection device of FIGS. 5 and 6,

FIG. 8 shows a section through the dust collection device along the section marked VIII-VIII in FIG. 7,

FIG. 9 shows a section through the dust collection device along the section marked VIII-VIII in FIG. 7, but in a changed operating position,

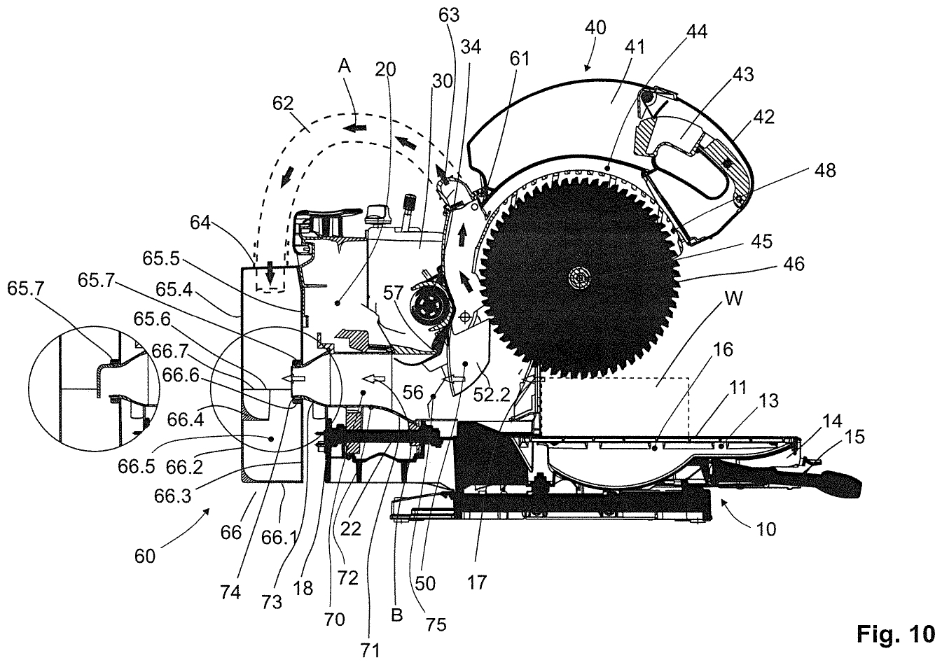

FIG. 10 shows a vertical section of the sliding compound miter saw of FIGS. 1-4,

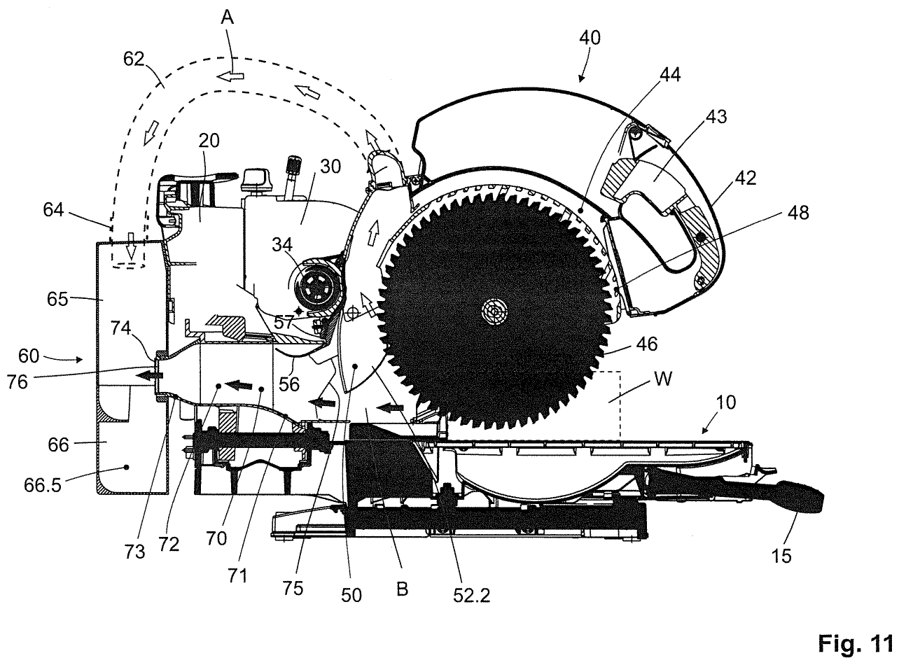

FIG. 11 shows a vertical section of the sliding compound miter saw of FIG. 10 in a changed operating position,

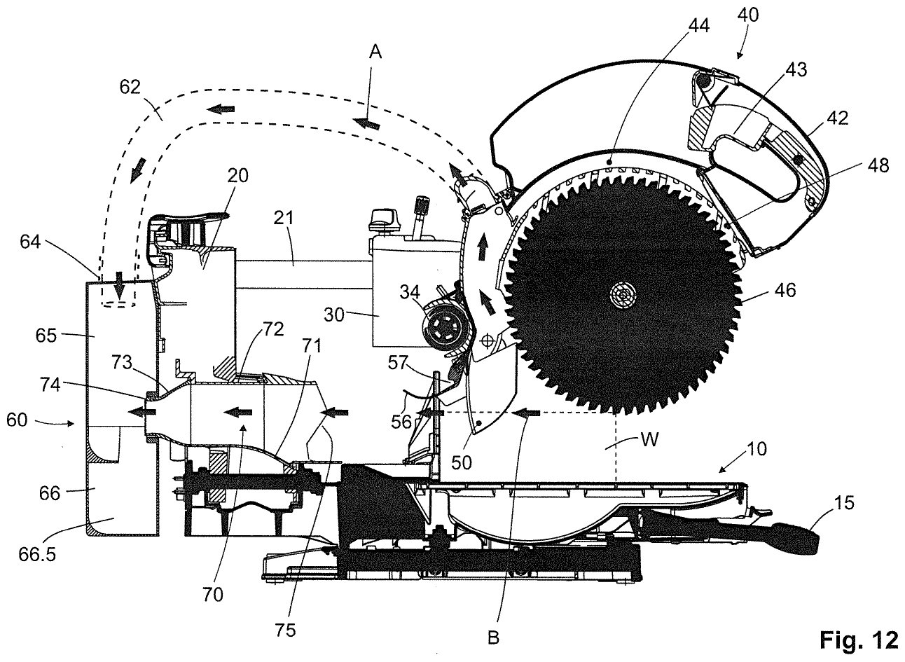

FIG. 12 shows the sliding compound miter saw of FIGS. 10 and 11 in a further changed operating position,

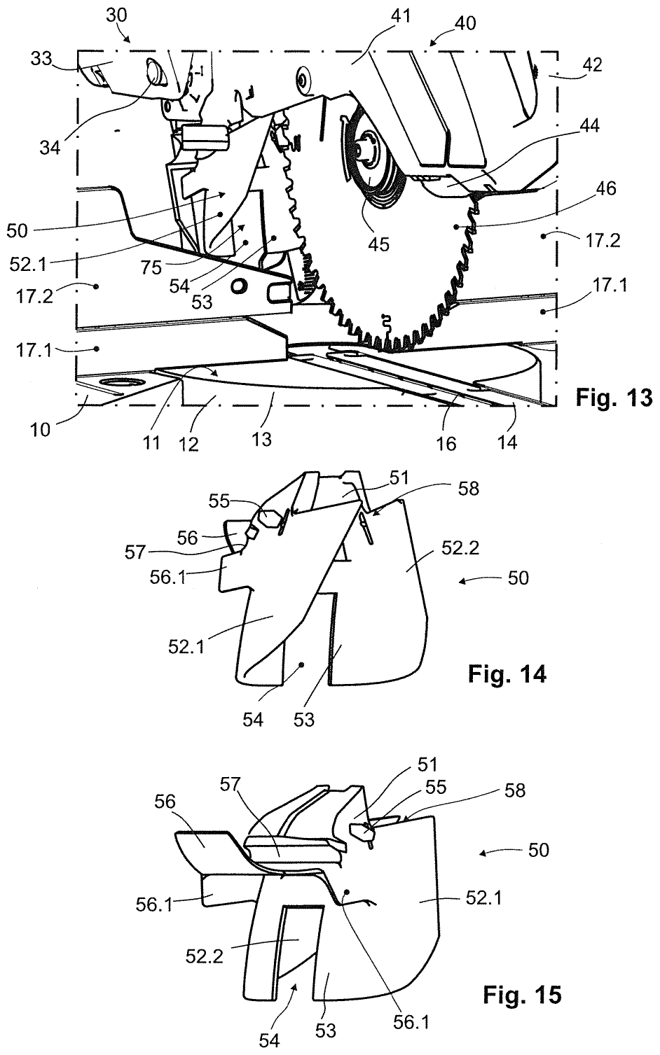

FIG. 13 shows a section of a detailed view of the sliding compound miter saw,

FIG. 14 shows a perspective front view of a chip routing element,

FIG. 15 shows a perspective rear view of the chip routing element of FIG. 14 and

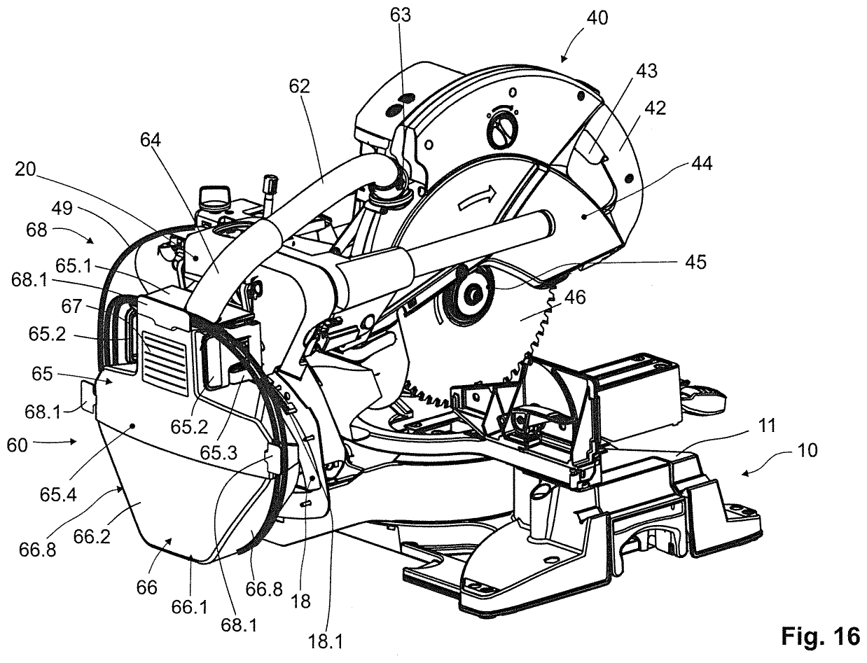

FIG. 16 shows the sliding compound miter saw of FIG. 3 having an alternative embodiment of the dust collection device.

FIG. 1 shows a circular saw, namely a sliding compound miter saw, which comprises a base part 10. The base part 10 has a base frame, which can be used to set up the sliding compound miter saw on a support surface. The base part 10 has a mount 12. A swivel unit 13 can be swivel mounted in this mount 12. The axis of rotation of the rotary unit 13 extends vertically to the supporting surface, on which the sliding compound miter saw can be set up. To swivel the rotary unit 13, an arm 14 is connected to the rotary unit 13, which projects forward beyond the base part 10. The arm 14 accommodates a locking mechanism 15. This locking mechanism 15 can be used to lock the set swivel position of the rotary unit 13.

The table 11 and the rotary unit 13 in conjunction form a workpiece support surface, on which a workpiece W (see FIG. 10) can be placed. A saw slot 16 is provided in the arm 14 and in the rotary unit 13. A saw blade 46 of the circular saw can plunge into this saw slot 16.

Stops 17 can be installed in the area of the workpiece support surface, as shown in FIG. 1. The stops 17 can be positioned on both sides of the saw slot 16 in a movable manner. The stops 17 can be designed in such a way that they comprise a stop piece 17.1, which is connected to the workpiece support surface. For sawing components having a large overall height, a cantilevered stop extension 17.2 can be attached to the stop piece 17.1.

The base part 10 has a support 18, to which a swivel arm 20 is attached in a swiveling manner. As FIG. 10 illustrates, a swivel bearing having a swivel axis 22 is used for this purpose, which swivel axis connects the swivel arm 20 to the support 18. In FIG. 10, the swivel axis 22 extends in a horizontal direction and in parallel to the workpiece support surface. Preferably, the swivel axis 22 is aligned with the saw slot 16.

FIG. 1 illustrates that the support 18 can comprise a scaling 18.1. The set swivel position of the swivel arm 20 can be taken from the scaling 18.1.

FIG. 1 shows an adjusting device 30 can be attached to the swivel arm 20. The adjusting device 30 can be moved linearly on a guide 21 of the swivel arm 20 in the direction of the longitudinal extension of the saw slot 16. For instance, as FIG. 1 shows, the swivel arm 20 can comprise two cantilevered guide rods extending in parallel to each other and forming the guides 21. The adjusting device 30 is guided on the guides 21 using sleeve-shaped guide necks 31. The guide necks 31 are interconnected via a connecting section 32.

The adjusting device 30 can comprise a support 33, to which a saw head 40 is attached in a swiveling manner. Preferably, the saw head 40 is swivel connected to the support 33 by means of a miter bearing 34. The swivel axis of the miter bearing 34 extends transverse to the swivel axis 22 of the swivel arm 20 and horizontally, i.e. in parallel to the workpiece support surface.

The saw head 40 has a housing 41, on which a handle 42 having a switch 43 can be disposed. The switch 43 is used to activate a motor 47 of the saw head 40. The motor 40 can drive a saw-blade holder 45 and in that way a saw blade 46 connected to the saw-blade holder 45.

FIG. 1 illustrates that the saw head 40 can comprise a protective saw blade cover 44. The protective saw blade cover 44 encloses the cutting edge of the saw blade 46 in the area of the top face of the circular saw and thus forms an access guard.

An adjustable protective cover 48 is connected to the protective saw blade cover 44. It can be swivel connected to the protective saw blade cover 44 in a known manner. The adjustable protective cover 48 can be used to enclose the lower part of the cutting edge of the saw blade 46. The adjustable protective cover can be swiveled to expose the cutting area of the saw blade 46 during operation. FIG. 10 shows that the adjustable protective cover 48 is at least partially swiveled into the housing 41 in the state in which it exposes the underside of the saw blade 46.

FIG. 1 shows the positioning of the saw head 40 in a fully swung-open position, wherein the adjusting device 30 is in a rear stop position.

FIG. 2 illustrates a position of the saw head 40, wherein the saw head 40 has been swiveled at least partially downwards about the miter axis of the miter bearing 34 in the direction of the workpiece support surface. Furthermore, it can also be seen that the adjusting device 30 has been adjusted linearly relative to the swivel arm 20 in the direction of a front stop position.

FIG. 3 shows the positioning of the saw head 40 as shown in FIG. 1, wherein the saw head 40 has been adjusted about the swivel axis of the miter bearing 34 in the direction of the workpiece support surface, however.

As FIG. 3 further shows, a dust collection device 60 is connected to the circular saw.

The dust collection device 60 has a first dust guide duct 60, which can, for instance, be formed by a flexible hose section, in particular by a corrugated hose. Preferably, the first dust guide duct 62 is connected to a hood adapter 61 of the protective saw blade cover 44. The first dust guide duct 62 may have a hose connector 63, which is detachably connected (without the need for tools) to the hood adapter 61.

FIG. 10 shows that the hood adapter 61 opens into a chip guide section of the protective saw blade cover 44. The chip guide section is part of the housing 41 and is used to collect chips produced during the machining of a workpiece W and to route them to the first dust guide duct 62 via the hood adapter 61. This is symbolized in FIG. 10 by the arrows shown in black. This results in an initial chip guideway.

At its end facing away from the hood adapter 61, the first dust guide duct 62 has an end piece, which is attached or guided to a duct port 65.1 of a holder 65 of the dust collection device 60.

For instance, the duct port 65.1 may comprise a guide piece 64, in which the first dust guide duct 62 is adjustably guided. Preferably, the guide piece 64 can accommodate the first dust guide duct 62 in such a way that the first dust guide duct 62 can be adjusted in the direction of its longitudinal extension relative to the guide piece 64.

FIG. 3 illustrates that the guide piece 64 can be formed by a tube section, into which the first dust guide duct 62 is inserted. Accordingly, the first dust guide duct 62 can be displaced inside the guide piece 64 in the direction of its longitudinal extension relative to the guide piece 64.

Advantageously, the dust collection device 60 has the holder 65 and a collection container 66. The collection container 66 can be detachably connected (without the need for tools) to the holder 65. FIGS. 5 and 6 show the design of the dust collection device 60 more clearly.

As illustrated in this representation, the holder 65 may comprise a front panel 65.4 and a rear panel 65.5 at a distance therefrom. The front panel 65.4 is connected to the rear panel 65.5 via lateral elements to form a partial housing.

This partial housing can be designed such that it has a retaining section 65.8, which bears the guide piece 64.

Additionally or alternatively, provision may also be made for the retaining section 65.8 to comprise one or more attachment devices 65.2 having locking elements 65.3. The attachment devices 65.2 can be used to detachably connect the holder 65 (without the need for tools) to the swivel arm 20. Preferably, the holder 65 is attached to the end of the swivel arm 40 facing away from the saw head 40.

FIG. 4 illustrates that the swivel arm 20 can comprise a fastening section 23, to which the holder 65 can be attached. The fastening section 23 can be such that it has two form-fitting locking elements 23.1 with which the locking elements 65.3 engage.

According to FIGS. 5 and 6, the rear panel 65.5 of the holder 65 may comprise a further duct port 65.7, which may take the form of an aperture.

As already mentioned above, the collection container 66 can be detachably connected (without the need for tools) to the holder 65. The (without the need for tools) detachable connection can, for instance, be formed by a plug-in connection that allows the collection container 66 to be removed from the holder 65.

The collection container 66 has a cover panel 66.2 and a rear panel 66.3 disposed at a distance therefrom. The cover panel 66.2 and the rear panel 66.3 are integrally interconnected via a bottom 66.1 and lateral casings 66.8. The lateral casings 66.1 may be disposed at a V-shaped angle and diverge starting from the bottom 66.1.

FIG. 10 shows a sectional view of the dust collection device 60. As this representation illustrates, the holder 65 forms a partial housing that is open at the bottom and the collection container 66 forms a partial housing that is open at the top. Openings 65.6 and 66.6 of the holder 65 and the collection container 66 are thus formed at the open sides to form a joint collection chamber 66.5 with the two partial housings. The opening 65.6. of the collection container 66 can also be referred to as the collection container opening.

FIG. 10 illustrates that one or more air guide elements 66.4 can be disposed in the collection chamber 66.5. An air guide element 66.4 can, for instance, be formed by a routing element which projects into the collection chamber 66.5.

The air guide element(s) 66.4 can advantageously be integrally formed on the holder 65 or the collection container 66. FIG. 10 also illustrates that the cover panel 66.2 and/or the front panel 65.4 can be disposed opposite from the duct port 65.7, which panel then also forms a routing element, which is used as a baffle plate for an air flow exiting the duct port 65.7.

FIG. 10 shows that a second dust guide duct 70 is provided on the circular saw. Preferably, the second dust guide duct 70 passes through the swivel arm 20. For this purpose, the swivel arm 20 can comprise a feed-through, in which the second dust guide duct 70 is installed.

The second dust guide duct is designed such that it forms a spatial connection between the collection chamber 66.5 and the area of the circular saw in which the saw head 40 is disposed.

The second dust guide duct 70 has a guide area 72 that passes through the swivel arm 20. Advantageously, an expansion section 71 of the second dust guide duct 70 may be connected to the guide area 72 in the direction of the saw head 40. Additionally or alternatively, provision may also be made for a taper section 73 to be provided at the area facing the collection container 66 and/or the dust collection device 60, wherein the taper section 73 reduces the size of the flow duct of the second dust guide duct 70. It can be particularly advantageous for the second dust guide duct 70, preferably for the taper section 73, to comprise a connection piece 74 for the duct port 65.7 of the dust collection device 60 at its end facing the dust collection device 60. Preferably, the connection piece 74 forms a connection fitting, which is inserted into the duct port 65.7 formed as a bore. The dust collection device 60 can then simply be removed from the second dust guide duct 70 or attached thereto.

It is conceivable that the second dust guide duct 70 is designed such that it forms an exit opening 76, which opens into the receiving chamber and/or the collection chamber 66.5. Opposite from the exit opening 76, the second dust guide duct 70 can face the saw head 40 and comprise an entry opening 75 in the area behind the stops 17. Preferably, a straight line of sight is formed between the entry opening 75 and the exit opening 76 through the swivel arm 20, as shown in FIG. 10.

FIG. 10 uses white arrows to illustrate a chip guideway B, via which chips removed from a workpiece W can be routed into the collection container 66 and collected in the collection chamber 66.5. Preferably, the collection chamber 66.5 comprises a collection area, which is disposed below the exit opening 76 and/or below the exit opening of the first dust guide duct 62 in the direction of gravity, such that the collected chips can settle in an orderly manner.

FIG. 10 illustrates that a chip routing element 50 can be connected to the saw head 40. FIGS. 14 and 15 show a possible design of the chip routing element 50.

As these representations show, the chip routing element 50 has a base part 51, which bears two spaced-apart legs 52.1, 52.2. This results in a guide area 58 between the two legs 52.1 and 52.2. The guide area 58 is open at the top such that a spatial connection is established with the area of the protective saw blade cover 44 that leads to the hood adapter 61. The two legs 52.1, 52.2 are connected to a board-shaped connecting section 53, which extends transverse to the longitudinal extension of the legs 52.1/52.2. A door-shaped or window-shaped aperture 54 is cut out of the connecting section 53. The aperture 54 is aligned with the blade plane of the saw blade 46, which can also be referred to as the saw blade plane. Preferably, the aperture 54 is recessed from the connecting section 53, as shown in FIGS. 14 and 15.

Provision may be made for a routing section 56 to be held, preferably integrally molded, on the base part 51. The routing section 56 can project from the base part 51 in the shape of a tongue. To stabilize the routing section 56, bars 56.1 can be provided, which stick out downwards and are formed on the routing section 56 on the one hand and on the connecting section 53 on the other hand. The routing section 56 and the bars 56.1 form a duct section to route chips emerging from the aperture 54 to the entry opening 75 of the dust guide duct 70. This is advantageous if the saw head 40 is in a forward position—further away from the swivel arm 20—as shown in FIG. 12.

As FIG. 15 illustrates, the base part 51 has fasteners 55. These fasteners 55 can be used to attach the chip routing element 50 to the saw head 40, in particular to the housing 41 of the saw head 40.

Preferably, the chip routing element 50 shown in FIGS. 14 and 15 is integrally made from an elastic material, for instance from a rubber or rubber-like material.

FIGS. 10 and 11 show the positioning of the chip routing element 50 in the assembled state. As FIG. 10 shows, the chip routing element 50 is attached to the saw head 40 in such a way that it covers a transition area between the miter bearing 34 and the second dust guide duct 70 to prevent the area behind from being contaminated with chips.

In the assembled state, a limiting edge of the second dust guide duct 70 engages with a groove-shaped receptacle 57 of the base part 51 in the area of the entry opening 75. This assignment enables the receptacle 57 to swivel about the limiting edge when the saw head is swiveled about the miter axis.

The routing section 56 is disposed and designed in such a way that it engages with the second dust guide duct 70 above the aperture 54 to route the chips coming from the workpiece W into the second dust guide duct 70.

Preferably, when the saw head 40 is in a swung-in sawing position, a straight line of sight is established from the receiving chamber and/or collection chamber 66.5 to the lower limiting edge of the saw blade 46, as shown in FIGS. 10 and 12.

The function of the circular saw is explained in more detail below. As FIG. 10 shows, a workpiece W can be placed on the workpiece support surface of the table 11. The saw head 40 is then brought into the desired sawing position. For this purpose, the adjusting device 30 is moved away from the swivel arm 20 as required and then the saw head 40 is swiveled about the miter axis of the miter bearing 34.

If necessary, the swivel arm 20 can also be adjusted in advance to the desired angular position in relation to the support 18 if a corresponding angled cut is to be made. The V-shaped lateral casings 66.8 of the collection container 66 prevent a collision with the supporting surface, on which the base part 10 is positioned.

When the saw head 40 is swiveled about the miter axis 34, the lower limiting edge of the saw blade 46 hits the workpiece W, as shown in FIG. 10. The introduction of a saw cut then separates sawdust from the workpiece W, which at the start of the sawing action is primarily conveyed backwards in the direction of the swivel arm 20, as shown by the white arrows. Accordingly, the chips are conveyed along a guideway B through the second dust guide duct 70 into the collection chamber 66.5. The chips hit the front panel 65.4 of the holder 65 or the cover panel 66.2 of the collection container 60 and/or the air guide element 66.4. This slows down the chips considerably and reduces their kinetic energy. The chips can then fall downwards in the direction of gravity into the collection chamber 66.5.

At the same time, chips are also transported along the chip guideway A during the cutting action, as shown by the black arrows in FIG. 10. These chips are transported via a guide area of the protective saw blade cover 44 to the hood adapter 61. From there, the chips pass into the first dust guide duct 62 and then into the collection chamber 66.5 of the dust collection device 60. Here again, the chips are slowed down by the one or more air guide elements 66.4 such that they can settle in the collection chamber 66.5.

To prevent the formation of excess pressure inside the collection chamber 66.5, provision may be made for the dust collection device 60 to have a venting aperture, which creates a spatial connection to the environment to form an exhaust air passage device 67, as shown in FIG. 16. This venting aperture can be covered by a filter element to prevent dust from the collection chamber 66.5 from escaping into the environment. Additionally or alternatively, a labyrinth can also be provided in the area of the venting aperture to prevent dust from escaping. It is also conceivable that the dust collection device 60 consists partly of an air-permeable surface material. For instance, a part of the collection container 66 or the collection container 66 as a whole may consist or predominantly consist of such an air-permeable surface material, for instance of a fabric. For instance, the fabric can be stretched by a wire frame to form the lateral casings of the collection container 66.

If the saw head 40 is displaced along the workpiece W during sawing, the spatial assignment of the hood adapter 61 to the dust collection device 60 changes. To avoid a strong bending of the first dust guide duct 62, it can be adjusted relative to the guide piece 64, as described above.

FIG. 8 illustrates a positioning of the first dust guide channel, in which the latter has been moved into the collection chamber 66.5 at the end. This corresponds, for instance, to the positioning of the saw head 40 as shown in FIG. 10. Positioning the saw head 40 as shown in FIG. 12 results in an arrangement as shown in FIG. 9, wherein the end of the first dust guide duct 62 is clearly moved out of the collection chamber 66.5 or out of the receiving chamber.

To empty the collection container 66, it can simply be detached from the holder 65 and the chips can be emptied via the opening 66.7. The collection container 66 can then be reattached to the holder 65.

FIG. 16 shows a further design variant of a circular saw. The design of this circular saw is essentially identical to the design of the circular saw as shown in FIGS. 1-15. In this respect, reference can be made to the above statements to avoid repetition. Therefore, only the differences will be discussed below.

As FIG. 16 shows, the dust collection device 60 has a cable receiving area 68 on its outer circumference. It is designed such that a connection cable 49 of the circular saw can be wound onto the cable receiving area 68. The cable receiving area 68 has molded elements 68.1, which are designed to prevent the connection cable 49 from slipping off the receiving area 68. The shaping elements 68.1 can be designed as molded-on or attached projections, which preferably project beyond the outer circumference of the dust collection device 60. It is also conceivable that one of the molded elements 68.1 or an additional component is provided, which comprises a clip element, into which the plug-side end of the connection cable 49 can be clipped, for the connection cable 49 to be held securely.

FIG. 16 further illustrates that the holder 65 of the dust collection device 60 may comprise an exhaust air passage device 67, wherein the exhaust air passage device 67 forms a spatial connection between the environment and the receiving chamber encompassing the dust collection device 60. Pressure equalization with the environment can occur via the exhaust air passage device 67, as already explained above.

1-21. (canceled)

22. A circular saw, comprising:
a base part including a support;
a swivel arm connected to the support such that the swivel arm can swivel about a swivel axis relative to the support;
a saw head carried by the swivel arm and configured to receive a saw blade on a saw-blade holder, the saw head being coupled to the swivel arm such that the saw head can swivel about a miter axis of a miter bearing relative to the swivel arm;
a protective saw blade cover configured to receive a portion of the saw blade; and
a dust removal system attached to an end of the swivel arm located away from the saw head, the dust removal system including a first dust guide duct, a second dust guide duct, and a collection container having a collection chamber for collecting saw dust from the first dust guide duct and the second dust guide duct, the first dust guide duct connecting the protective saw blade cover to the collection chamber, and the second dust guide duct extending transverse to the miter axis through or past the swivel arm to the collection chamber.

23. The circular saw of claim 22, wherein:
the base part includes a table having a workpiece support surface; and
the second dust guide duct extends through the swivel arm and includes an entry opening facing the table and an exit opening at the end of the swivel arm located away from the saw head, a straight line of sight being formed between the exit opening and the entry opening in a direction of an axis extending parallel to the workpiece support surface.

24. The circular saw of claim 22, wherein:
the base part includes a table having a workpiece support surface; and
the second dust guide duct extends in an area between the miter axis of the miter bearing and the workpiece support surface of the table.

25. The circular saw of claim 22, wherein:
the second dust guide duct has a cross-section that increases in a direction facing away from the collection chamber.

26. The circular saw of claim 25, wherein:
the second dust guide duct includes a guide area, a taper section which reduces the cross-section of the second dust guide duct from the guide area toward the collection chamber, and an expansion section which increases the cross-section of the second dust guide duct from the guide area away from the collection chamber, the taper section and the expansion section being integrally connected to the guide area.

27. The circular saw of claim 22, wherein:
the first dust guide duct includes a hose section having an end located away from the saw head guided in a longitudinally displaceable manner in or on a guide piece of the dust removal system.

28. The circular saw of claim 27, wherein:
the hose section is guided on the guide piece such that in different setting positions of the saw head a free end of the hose section protrudes different lengths into an area encompassed by the dust removal system.

29. The circular saw of claim 28, wherein:
the guide piece is formed by a tube section in which the hose section is received in a longitudinally displaceable manner.

30. The circular saw of claim 22, wherein:
the swivel arm includes a fastening section;
the dust removal system includes a holder attached to the fastening section; and
the collection container is detachably attached to the holder.

31. The circular saw of claim 22, wherein:
the dust removal system includes a first port and a second port, the first dust guide duct being connected to the first port, and the second dust guide duct being connected to the second port.

32. The circular saw of claim 22, wherein:
the base part includes a table having a workpiece support surface; and
the saw head includes a chip routing element connected to the protective saw blade cover, the chip routing element including two legs delimiting a guide area, the chip routing element including an aperture which at least in a swing-in cutting position of the saw head establishes a spatial connection between the second dust guide duct and a work holding device of the table.

33. The circular saw of claim 32, wherein:
the saw head includes a routing section at least partially covering a transition area between an entry opening of the second dust guide duct and the protective saw blade cover.

34. A dust collection system for a circular saw, comprising:
a holder;
a collection container detachably connected to the holder and forming a collection chamber; and
first and second separate duct ports configured to establish an air-conveying connection between the collection chamber and a surrounding environment and to which first and second dust guide ducts can be or are connected.

35. The dust collection system of claim 34, wherein:
the holder includes an attachment device including a locking element configured to connect the holder interchangeably to a circular saw.

36. The dust collection system of claim 34, wherein:
the holder includes the first and second separate duct ports.

37. The dust collection system of claim 34, wherein:
the holder forms a partial housing; and
the collection container forms a further partial housing, each of the two partial housings defining partial cavities which in an assembled state of the partial housings jointly form the collection chamber.

38. The dust collection system of claim 34, wherein:
the collection container includes a bottom, two mutually opposite lateral casings connected to the bottom and set in a V-shape relative to each other and diverging in a direction away from the bottom, a rear panel and a cover panel connected to the lateral casings.

39. The dust collection system of claim 34, wherein:
the collection container includes at least one air guide element connected to a panel of the collection container and projecting into the collection chamber.

40. The dust collection system of claim 34, wherein:
the collection container includes an exhaust air passage communicated with the collection chamber.

41. The dust collection system of claim 34, wherein:
the collection container includes a cable receiving area provided on an outer circumference of the collection container, the cable receiving area including a shaped element configured to prevent a connection cable wound around the outer circumference of the collection chamber from slipping off of the cable receiving area.
